(19) United States
(12) Patent Application Publication
(10) Pub. No.: US 2018/0320484 A1
(43) Pub. Date: Nov. 8, 2018

(54) HYDRAULIC FRACTURING DESIGN

(71) Applicant: SCHLUMBERGER TECHNOLOGY CORPORATION, Sugar Land, TX (US)

(72) Inventors: Elizaveta Gordeliy, Cambridge, MA (US); Romain Charles Andre Prioul, Cambridge, MA (US); Sylvain Nintcheu Fata, North Reading, MA (US)

(21) Appl. No.: 15/773,301

(22) PCT Filed: Oct. 26, 2016
(86) PCT No.: PCT/US2016/058725

§ 371 Date: May 3, 2018

Related U.S. Application Data
(60) Provisional application No. 62/251,238, filed on Nov. 5, 2015.

(51) Int. Cl. E21B 41/00; E21B 43/26; E21B 43/267; E21B 49/00; E21B 47/00; G06Q 30/02

(52) U.S. Cl. CPC E21B 41/0092; E21B 43/26; E21B 43/267; E21B 34/06; E21B 47/00; G06Q 30/0206; E21B 49/00

(57) ABSTRACT

Hydraulic fracturing design is provided. In one possible implementation, a computer-readable tangible medium includes instructions directing a processor to access initial conditions of a wellbore as well as potential completion types. The computer-readable tangible medium also has instructions directing the processor to determine a desirable finalized fracturing design for the wellbore by iteratively varying one or more fracturing properties for each of the potential completion types.

### CROSS-REFERENCE TO RELATED APPLICATION

The present document is based on and claims priority to U.S. Provisional Application Ser. No. 62/251,238, filed Nov. 5, 2015, which is incorporated herein by reference in its entirety.

### BACKGROUND

Hydraulic fracturing can be employed to enhance the productivity of wellbores in hydrocarbon bearing formations, including in so-called “tight” or “unconventional organic-rich shale” formations where reservoir permeability is otherwise too low for economic production.

Under the process of hydraulic fracturing, a number of different sequences, or ramps, can be pumped into a formation. The first ramp can be used to initiate and grow a small fracture, called a “calibration fracture” in the formation (also called “initiation/breakdown” sequence), which can be used to determine the instantaneous shut-in pressure (ISIP) in the formation at the point of the calibration fracture.

After this initial “initiation/breakdown” sequence, the main fracturing ramp can occur. This can involve re-pressurizing the wellbore with viscous gel or non-viscous “slickwater” type fluids at high rates (including, for example, up to 60 bbl/min) to force open rock in the formation against existing in-situ stresses, and generate narrow fractures, either planar or in complex network forms. During this process proppant can be tailed in at concentrations ranging from, for example, 0.5 PPA to 10 PPA. Proppant (such as sand, sintered bauxite, etc.) can be used to pack the fracture and maintain conductive fluid flow channels after the fracturing pressure is removed and the in-situ stresses attempt to re-close the fracture.

### SUMMARY

Hydraulic fracturing design is provided. In one possible implementation, a computer-readable tangible medium includes instructions directing a processor to access initial conditions of a wellbore as well as potential completion types. The computer-readable tangible medium also has instructions directing the processor to determine a desirable finalized fracturing design for the wellbore by iteratively varying one or more fracturing properties for each of the potential completion types.

In another possible implementation, a computer-readable tangible medium includes instructions directing a processor to access initial conditions of a wellbore as well as potential completion types. The computer-readable tangible medium also has instructions directing the processor to isolate several finalized fracturing designs associated with each of the potential completion types. The computer-readable tangible medium further has instructions directing the processor to choose a desirable finalized fracturing design from the finalized fracturing designs.

In yet another possible implementation, a computer-readable tangible medium includes instructions directing a processor to access initial conditions of a wellbore along with a potential completion type. The computer-readable tangible medium also has instructions directing the processor to isolate a finalized fracturing design associated with the potential completion type by varying one or more fracturing properties. In one possible aspect, the finalized fracturing design includes a pressure of fracturing fluid low enough to be at or below an allowable peak pressure and high enough to initiate and propagate a fracture in a formation with an opening at or above an allowed threshold value.

This summary is not intended to identify key or essential features of the claimed subject matter, nor is it intended to be used as an aid in limiting the scope of the claimed subject matter.

### BRIEF DESCRIPTION OF THE DRAWINGS

Features and functions of the described implementations can be more readily understood by reference to the following description taken in conjunction with the accompanying drawings.

FIG. 1 illustrates an example wellbore in which embodiments of hydraulic fracturing design can be employed;

FIG. 2 illustrates another example wellbore in which embodiments of hydraulic fracturing design can be employed;

FIG. 3 illustrates an example improvement workflow in accordance with embodiments of hydraulic fracturing design;

FIG. 4 illustrates an example reduction routine in accordance with embodiments of hydraulic fracturing design;

FIG. 5 illustrates example completion geometries of initial defects for 2D and axisymmetric modeling configurations in accordance with embodiments of hydraulic fracturing design;

FIG. 6 illustrates example completion geometries of initial defects for 3D modeling in accordance with embodiments of hydraulic fracturing design; and

FIG. 7 illustrates an example computing environment that can be used in accordance with various implementations of hydraulic fracturing design.

### DETAILED DESCRIPTION

In the following description, numerous details are set forth to provide an understanding of some embodiments of the present disclosure. However, it will be understood by those of ordinary skill in the art that the systems and/or methodologies disclosed herein may be practiced without these details and numerous variations and/or modifications from the described embodiments may be possible.

In one possible implementation, elements of hydraulic fracturing design can be used to create desirable fractures in a formation, and properly deploy proppant in the fractures, at pressures low enough to avoid damaging equipment and structures associated with a wellbore. In one possible aspect, this can include modeling hydraulic fracture initiation and propagation in the formation using a numerical algorithm coupling flow of the fracturing fluid and deformation of materials in the surrounding formation.

It will be understood that the term “optimize” as used herein can include any improvements up to and including optimization. Similarly the term “improve” can include optimization. Other terms like “minimize” and “maximize” can also include actions reducing and increasing, respectively, various quantities and qualities.

It will additionally be understood that the term “threshold” as used herein can include a boundary, limit and/or value approached from any direction.

Additionally, some examples discussed herein may involve technologies from the oilfield services industry. It will be understood however that the technologies and techniques of hydraulic fracturing design can also be used in a wide range of industries outside of oilfield services.

### Example Wellbore(s)

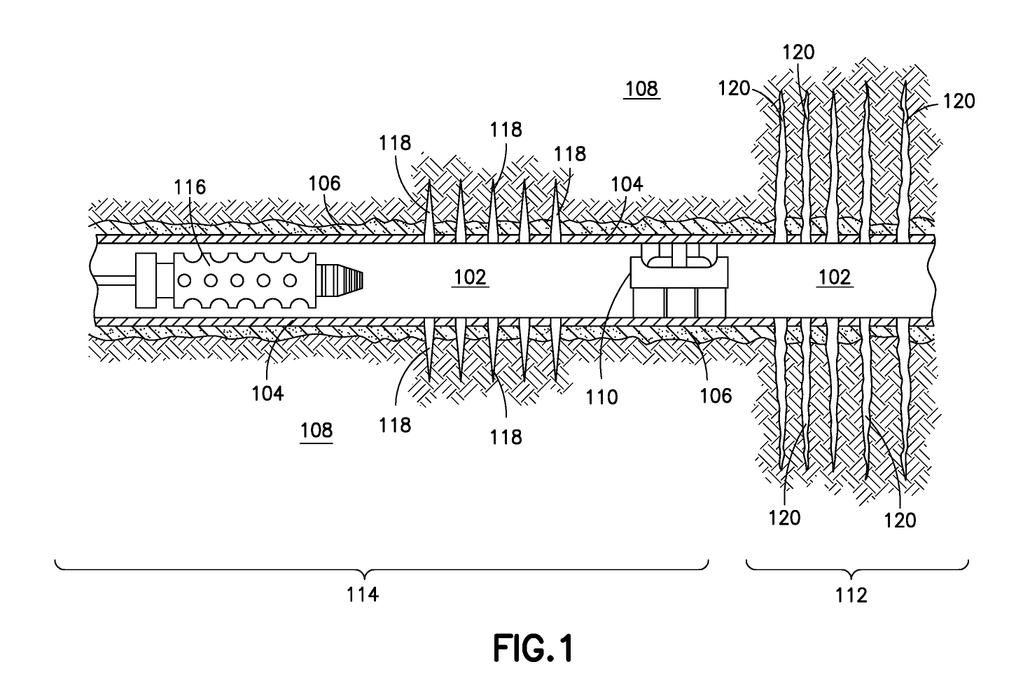

FIG. 1 illustrates an example wellbore 102 in which some embodiments of hydraulic fracturing design can be pursued. Wellbore 102 can be onshore or offshore and can be formed in any manner known in the art. Wellbore 102 can be horizontal, vertical, deviated, or any combination thereof. Similarly, wellbore 102 can be subjected to a variety of different fracturing operations.

For example, in FIG. 1 a plug and perforation operation in wellbore 102 is illustrated. As shown, a casing 104 can be fixed in place inside wellbore 102 using cement 106. In one possible implementation, casing 104 can hydraulically isolate wellbore 102 from a formation 108 surrounding wellbore 102. In one possible aspect, a plug 110, such as a packer, etc., can be set inside casing 104 hydraulically isolating a first section 112 of wellbore 102 from a second section 114 of wellbore 102.

A tool 116, such as, for example, a wireline tool, can be run into wellbore 102 to explosively perforate casing 104 and form perforations 118 into formation 108, providing hydraulic connectivity between wellbore 102 and formation 108. Tool 116 can then be removed and fracturing fluid and proppant can be introduced under pressure into casing 104, expanding perforations 118 into fractures 120 in formation 108. In one possible embodiment, fracturing fluid can be used in initial ramps, and proppant can be added to the fracturing fluid in subsequent ramps. Moreover, in some possible implementations, different types of fracturing fluid can be used in various ramps. For example, one type of fracturing fluid may be used in an initial ramp, and another type of fluid may be used with proppant in a subsequent ramp such as, for example, to maintain an opening of fractures 120, created during previous ramps. Moreover, in some possible implementations, the pressure with which fracturing fluid(s) are pumped into formation 108 may vary during the various ramps in order to accomplish desired objectives (such as creating and/or propagating fractures 120, dispersing proppant into fractures 120, etc.) while avoiding various problems, such as, for example, damaging wellbore 102, damaging a wellhead associated with wellbore 102, damaging pumps, completions elements and/or structures associated with wellbore 102, etc.

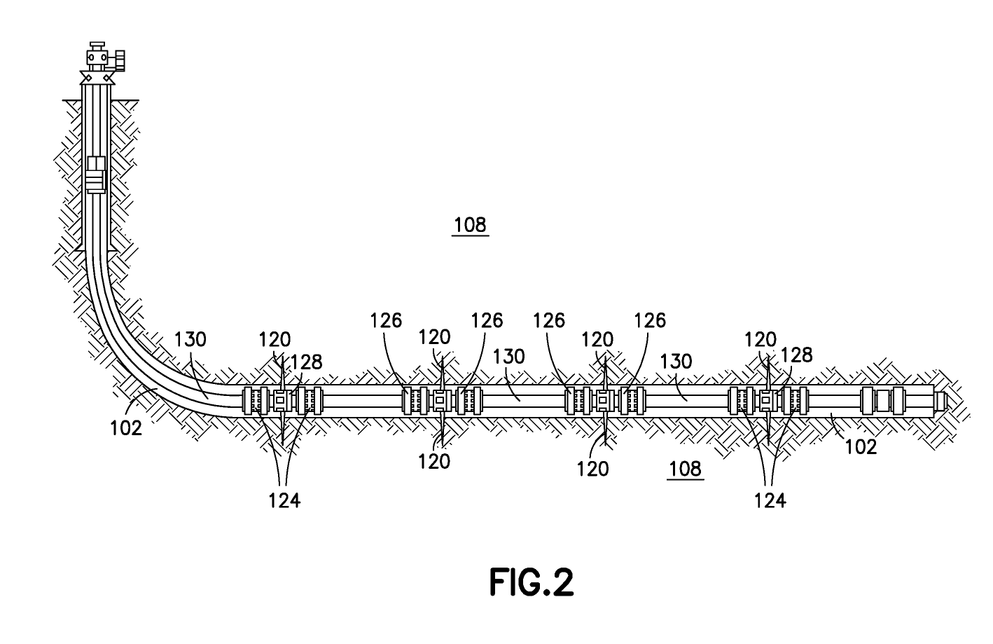

FIG. 2 illustrates example wellbore 102 undergoing sliding sleeve hydraulic fracturing in accordance with some embodiments of hydraulic fracturing design. In one possible implementation, sliding sleeve fracturing operations can utilize an installed completion string 124 comprising multiple isolation packers 126 and fracture sleeves 128, as well as production tubing 130, inside wellbore 102. In one possible aspect, wellbore 102 undergoing sliding sleeve hydraulic fracturing can be an open-hole wellbore. In another possible aspect, completion string 124 can be permanently installed in wellbore 102.

In one possible implementation, mechanically actuated valves in completion string 124 can be utilized to expose areas of formation 108 (for example, adjacent to fracture sleeve 128) to fracturing fluids under pressure flowing through completion string 124. These fracturing fluids, which in some ramps can also include proppant, can develop fractures 120 in formation 108. In one possible implementation, desired zones of wellbore 102 can be subjected to the pressurized fracturing fluid through use of the mechanically actuated valves, while other areas of wellbore 102 can be hydraulically isolated from the fracturing fluid by isolation packers 126. For example, in one possible aspect, the mechanically actuated valves can be activated by a given diameter ball being dropped into the fracturing fluid and pumped via completion string 124 to a seat designed to receive the ball's particular diameter.

It will be understood that even though FIG. 1 and FIG. 2 illustrate two hydraulic fracturing methods, the concepts of hydraulic fracturing design can be used with any fracturing methods known in the art.

Example System(s), Method(s) and/or Technique(s)

When fracking a well, issues often arise in deploying fracturing fluid at pressures in an allowable operating range which is simultaneously low enough to avoid damaging equipment associated with wellbore 102 (i.e. below a preset equipment limit for the equipment and/or structures associated with the wellbore), but high enough to create desirable fractures 120 and correctly deploy proppant in the fractures 120 such that deleterious issues, including near-wellbore screen-out, are avoided. In one possible implementation, equipment and structures associated with wellbore 102 can include, for example, various casings, completions equipment, pumps, wellhead equipment, various structures (such as natural fractures and/or imperfections in formation 108 proximate wellbore 102), etc.

Fracturing fluid pressures can ebb and flow during the fracturing process. For example, in a pad injection phase (such as, for example, before proppant is added to fracturing fluid), the pressure of the fracturing fluid may reach a peak, known as fracture breakdown pressure, after which the fracturing fluid pressure may subside. The pressure of the fracturing fluid may then ramp up again during a proppant injection stage.

In one possible implementation, pressures to initiate and propagate fractures 120 from wellbore 102 into formation 108 (with given principal stress magnitudes and orientations as well as properties of formation 108, etc.) can depend on operational hydraulic parameters (such as fracturing fluid properties and injection rates) as well as on the design of completions (such as types, selections and placements of plugs 110, and/or a completion string 124—along with its isolation packers 126 and fracture sleeves 128, etc.) in wellbore 102.

Moreover, for a given completion type (e.g. open-hole, cased hole, etc.), pressures of fracturing fluids experienced during a well fracturing operation can also be associated with a geometry of an initial defect associated with the formation 108 (including in formation 108) exposed to fracturing fluids from wellbore 102. Initial defects can include perforations 118, sleeves, notches, natural defects (such as naturally present small cracks), etc., at a surface of formation 108 exposed to wellbore 102.

In one possible embodiment, if fracture 120 initiates and propagates from wellbore 102, and the initial defect from which fracture 120 initiates is misaligned with the far-field stress directions in formation 108, fracture 120 can be reoriented towards a desired fracture plane, i.e. a plane perpendicular to the minimum far-field stress. This phenomenon of curving of any fracture paths from an initiation site on wellbore 102 (such as an initial defect on a surface of formation 108) towards a desired fracture plane is often called near-wellbore (NWB) fracture tortuosity. In one possible aspect, when high stresses are present in formation 108, rather than being opened as it would be in a desired fracture plane out into formation 108 away from wellbore 102, the opening of fracture 120 can be restricted near to wellbore 102. Such a restriction of fracture 120 can result in a reduced opening of fracture 120, creating a risk of fracture pinching which may trap proppant in a pinched section of fracture 120 causing a screen-out of wellbore 102 due to proppant bridging. A reduction of the opening of fracture 120 near wellbore 102 can also generate a near-wellbore pressure loss, which can contribute to over pressuring wellbore 102 and under pressuring fracture 120.

In one possible implementation, the use of a fracturing fluid with a higher fluid viscosity and/or a larger injection rate can result in a larger fracture reorientation distance, a less curved fracture path and a wider near-wellbore opening of fracture 120, which can reduce the risk of a screen out. On the other hand, the pressure of fracturing fluid in wellbore 102 to propagate the fracture 120 can be larger for larger fluid viscosity and larger injection rate. In addition, increased injection rate can also increase perforation friction. In one possible aspect, a change of fluid properties (such as properties of fracturing fluids) with temperature and time can also affect the increase of pressure due to the NWB fracture tortuosity.

Other factors exist that can influence fracture pinching and increase pressure due to NWB fracture tortuosity. These include completion type and/or the geometry of the initial defect exposed to the pressure of the fracturing fluid. For example, if perforations 118 in a cased wellbore 102 are misaligned with the in-situ principal stress directions in formation 108, a fracture 120 can initiate at a tip of a perforation tunnel (away from wellbore 102) or from a base of the perforation tunnel (near wellbore 102). Moreover, a micro-annulus can be formed between formation 108 and cement 106, between cement 106 and casing 104, or between any other locations known in the art.

In one possible embodiment, if a perforation tunnel of a perforation 118 is long enough and is oriented with an angle from a desired fracture plane below a given threshold, fracture 120 can initiate and propagate from perforation 118. However, if the perforation misalignment is larger than the given threshold, a danger exists that fracture 120 can initiate from a micro-annulus formed as described above. In some instances, the threshold angle from the desired fracture plane can be 10-20 degrees, though in others (such as in vertical wells, for example) the threshold angle can be as high as 60 degrees.

In one possible implementation, misalignment of perforations 118 with a desired fracture plane can also influence pressure loss and aperture reduction due to NWB fracture tortuosity. For example, for a vertical wellbore 102, a lower angle of misalignment between perforations 118 and the desired fracture plane can result in a lower viscous pressure drop near wellbore 102 and a lower breakdown pressure.

Moreover, in one possible implementation, if multiple fractures 120 are initiated from a wellbore 102, the fractures 120 can compete for opening space. Additionally, in one possible aspect, a larger fluid viscosity of the fracturing fluid can reduce the number of fractures 120 that propagate in response to the fracturing fluid. For multiple fractures 120 initiating from a vertical open-hole wellbore 102, in one possible embodiment, a bi-wing fracture 120 may eventually be formed. In one possible aspect, fracture competition in the near-wellbore region may have different behavior for cased perforated completions due to a larger compressive stress concentration in the vicinity of wellbore 102, and the open hole completion (such as completion string 124, for example) may be more desirable since it may potentially decrease and/or minimize any NWB fracture tortuosity problems.

Additionally, in one possible implementation, when fracture 120 propagates, an opening of fracture 120 can increase. In such a case, to avoid near-wellbore screen-out, proppant injection can be delayed until the opening of fracture 120 is large enough to avoid such screen-out.

This disclosure provides several examples of issues that can be encountered during a well fracturing operation, though it will be understood that many other issues can be also encountered. Various aspects of hydraulic fracturing design can be useful in ameliorating and/or avoiding such issues through customization of various design parameters including, for example, a completion type, a geometry of an initial defect, and/or the operational hydraulic parameters associated with a well fracturing operation.

For example, in one possible implementation, the various design parameters can be customized to influence fracturing fluid pressures to initiate fractures 120 from initial defects not residing in a desired fracture plane, such that the fractures 120 propagate through the NWB tortuous region.

In another possible example, an improvement workflow in conjunction with aspects of hydraulic fracturing design can be useful in obtaining one or more sets of parameters to decrease and/or minimize the pressure of the fracturing fluid during the fracturing operation, while providing a fracture opening sufficient for proppant placement and screen-out avoidance in fracture 120.

Moreover, in another possible implementation, in order to keep the pressure of the fracturing fluid within an allowable operating range during a well fracturing operation, elements of hydraulic fracturing design can be used to locate a desirable completion design as well as desirable operational hydraulic parameters to be used during the fracturing process. In one possible aspect, this can be accomplished by, for example, employing operational hydraulic fracturing parameters and a completion design configured to decrease a peak pressure of fracturing fluid pumped into formation 108, such that the fracturing fluid initiates and propagates a potentially tortuous hydraulic fracture 120 from borehole 102 into formation 108 while avoiding screen out and other potential issues.

Such an improved workflow can be subject to a variety of factors including, for example, a minimum allowable fracture opening constraint for each potential completion type to be considered for wellbore 102. In one possible implementation, the minimum allowable fracture opening can be determined based on a type of proppant being used. For example, in some possible aspects, it may be desirable to have the minimum allowable fracture opening be 2-3 times (or more) larger than the maximum diameter of the proppant being used in order to preclude issues such as clogging of fracture 120, etc.

Other factors that can potentially influence such an improved workflow include the geometry of an initial defect (which can be varied) as well as hydraulic parameters in a stage; choosing an improved (and/or optimal) completion type based on the obtained peak pressure; and providing improved (and/or optimal) operational hydraulic fracturing parameters and an improved (and/or optimal) completion design for the chosen completion type and stage. In one possible implementation, a fracturing stage, or simply a stage, can be a hydraulically isolated section of a well (such as, for example, sections 112, 114 in wellbore 102) for which fracturing operations can be performed. Moreover, a cluster can be a set of initial defects in formation 108.

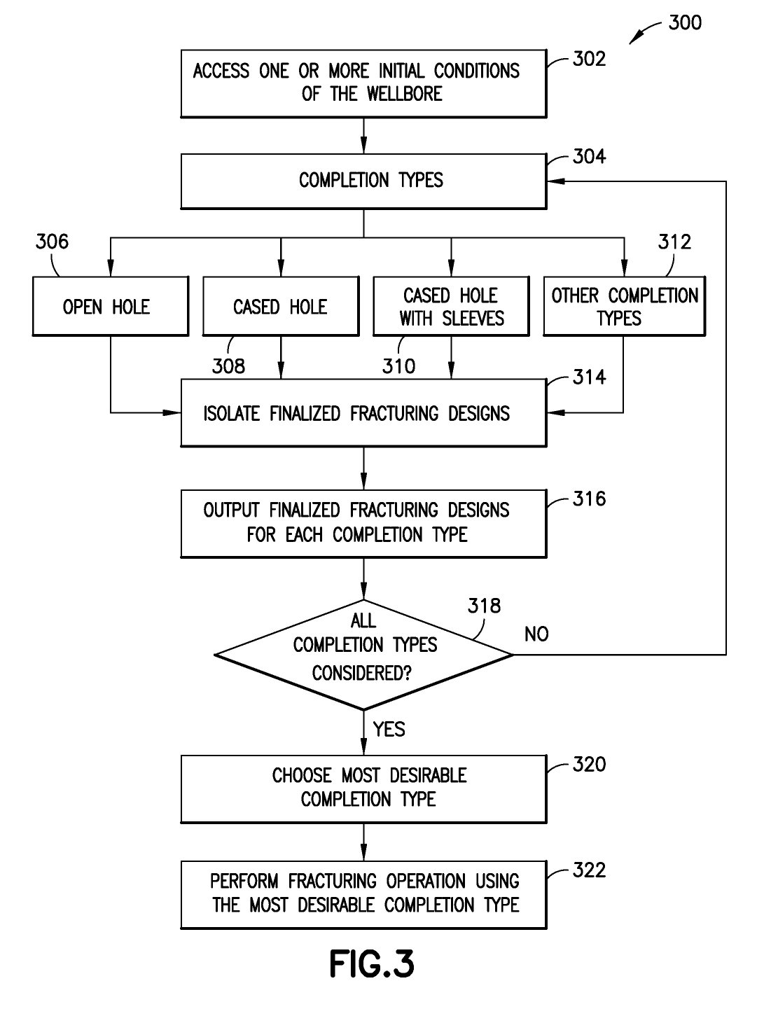

FIG. 3 illustrates an example improved workflow 300 in accordance with embodiments of hydraulic fracturing design. At block 302 one or more initial conditions of wellbore 102 are accessed. The initial conditions of wellbore 102 can include any information regarding wellbore 102 and formation 108, such as, for example, a geometry of wellbore 102 (e.g. vertical, horizontal, deviated, etc.), measured geomechanical properties of formation 108 (such as principal stress magnitudes and orientations, rock properties, etc.), equipment and/or structures present in wellbore 102 and/or associated with wellbore 102, etc. For example, in one possible implementation, one possible initial condition of wellbore 102 can include information associated with a specified depth of a stage (such as sections 112, 114) in wellbore 102.

At block 304, improvement workflow 300 accesses potential completion types. These can include any type of completion types known in the art, including open hole 306, cased hole 308, cased hole with fracturing sleeves 310, and others 312. In one possible implementation, if a given completion type cannot be used with wellbore 102 and/or the given completion type is disfavored for any reason, workflow 300 can be simplified by ignoring the given completion type at block 304.

At block 314, for each completion type accessed at block 304, a finalized fracturing design is isolated having a pressure of fracturing fluid within an allowable operating range that is low enough to be at or below an acceptable peak pressure to avoid damaging wellbore 102 (and/or equipment and structures associated therewith), and high enough at the end of a pad such that a fracture opening of fracture 120 is no smaller than a given allowed threshold value, such that deleterious issues including screen-out, etc., are avoided. In one possible implementation, the given allowed threshold value can be obtained from specifications of one or more proppants contemplated for use in the well fracturing operation in wellbore 102. Similarly, in one possible aspect, an output closure stress of fracture 120 can provide guidance on the strength of proppant to be injected into fracture 120. Moreover, in one possible embodiment, the allowable peak pressure can be assessed through study of various specifications of equipment and/or structures associated with wellbore 102.

It will be also understood that several fracturing fluids can be used during a well fracturing operation, thus the pressure of fracturing fluid discussed herein includes the highest pressure of any fracturing fluid which may be contemplated for use in a well fracturing operation.

In one possible embodiment, isolating a finalized fracturing design for each completion type can include creating a plurality of possible fracturing designs for each potential completion type and choosing the desirable possible fracturing design (i.e. the possible fracturing design with lowest pressure of fracturing fluid, the cheapest and/or easiest possible fracturing design to implement, etc.) to be the finalized fracturing design for the completion type.

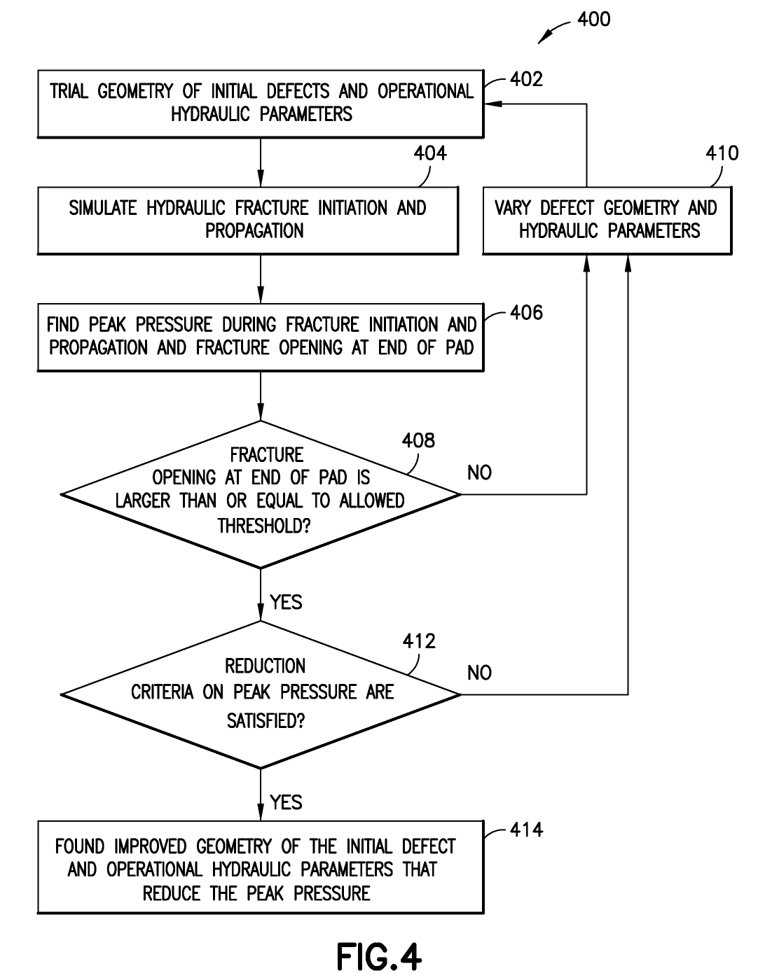

In one possible implementation, each finalized fracturing design is isolated by varying one or more of a variety of fracturing properties to arrive at a pressure of fracturing fluid in the allowable operating range. In one possible implementation, fracturing properties can include, for example: one or more operational hydraulic parameters (such as, for example, properties of the fracturing fluid(s) contemplated for use in the well fracturing operation); one or more properties associated with one or more initial defects in formation 108 adjacent to wellbore 102, etc. In one possible aspect, all or part of the functions described in block 314 can be achieved through implementation of a reduction routine, such as reduction routine 400 described in conjunction with FIG. 4 below.

Properties of the fracturing fluid(s) can include anything known in the art including, for example, fluid viscosities for Newtonian fluids, rheological properties for non-Newtonian fluids, injection rate schedules, etc. Similarly, the term initial defects as used herein can include any initial defects known in the art, including for example, man-made defects (such as perforations 118, notches, sleeves, etc.) and naturally occurring defects (such as cracks in formation 108, etc.).

The properties associated with initial defects considered at block 314 can include any properties known in the art, including, for example: geometries of the initial defects, a number of the initial defects, a diameter and/or diameters of the initial defects, a depth and/or depths of penetration of the initial defects into formation 108, a spacing and/or placement of the initial defects, etc.

In one possible aspect, when the initial defects are notches in formation 108, a reduction routine, such as reduction routine 400, may be employed in which a variety of factors including a depth of penetration of the notches into formation 108, an angular extent of the notches into formation 108, a location and orientation of the notches with respect to the direction of wellbore 102, etc., can be considered with the intent of decreasing and/or minimizing a pressure of fracturing fluid to safely initiate and propagate fractures 120 while avoiding the various issues described herein, including, for example, screen-out.

In the event that no initial defects are introduced into formation 108, or if the completion design in wellbore 102 is fixed for a particular completion type (e.g. for open hole or cased-hole completion with fracturing sleeves), initial defects can be ignored in block 314, and other aspects of the well fracturing procedure, including, for example, other fracturing properties such as properties of the fracturing fluid(s), injection rate schedules, etc., can be considered and manipulated with the intent of decreasing and/or minimizing a pressure of fracturing fluid to safely initiate and propagate fracture 120 while avoiding the various issues described herein, including, for example, screen-out, damage to wellbore 102, and/or equipment associated therewith, etc.

At block 316, a variety of information can be output for each finalized fracturing design isolated for each of the various completion types in block 314. This variety of information can include anything isolated in block 314 and/or anything associated with the finalized fracturing designs including, for example, types of completions, fracturing properties (including hydraulic parameters and/or initial defect types and their depths, locations, etc.), minimum fracture openings at the end of each pad, closure stresses, trajectories of fractures 120, pressures of fracturing fluid calculated during each pad, improved completion designs, etc.

At block 318, if all of the completion types 306, 308, 310, and 312 have not yet been considered, then improvement workflow 300 returns to block 304. In this way improvement workflow 300 can cycle through all of the various completion types 306, 308, 310, and 312.

Once all the completion types 306, 308, 310, and 312 have been considered, and finalized fracturing designs have been isolated for them at block 314, improvement workflow 300 moves to block 320 where a desirable completion type can be chosen. The choice of desirable completion type at block 320 can be based on a variety of factors including, for example, a minimum pressure of fracturing fluid achieved for the completion type in accordance with its associated finalized fracturing design as isolated in block 314, a cost of implementing a completion design incorporating the desirable completion type (wherein the cost can include the time and/or difficulty of implementing the completion design), possible field restrictions associated with the completion type, etc.

In one possible implementation, the finalized fracturing design associated with the desirable completion type can be termed the desirable finalized fracturing design. Moreover, in one possible implementation, the desirable completion type may be chosen because it is associated with the desirable finalized fracturing design.

At block 322, the fracturing operation can then be performed using the finalized fracturing design associated with the desirable completion type (i.e. the desirable finalized fracturing design).

Although the description above is detailed for a single cluster within a stage, improvement workflow 300 could also be considered for multiple clusters at fixed locations in a single stage, whereby the locations of the clusters can be based on the properties of formation 108.

In addition, improvement workflow 300 could be augmented to include the improvement and/or optimization of the locations of the clusters within a stage.

FIG. 4 illustrates an example reduction routine 400 in accordance with embodiments of hydraulic fracturing design. In one possible implementation, reduction routine 400 can be used to implement some or all of the functions (and achieve some or all of the goals) associated with block 314 in FIG. 3.

At block 402, a trial geometry of one or more initial defects on a surface of formation 108 adjacent to wellbore 102 as well as operational hydraulic parameters (such as, for example, properties of fracturing fluid(s) and injection rates contemplated for use in a well fracturing operation) are accessed for a given completion type. In some possible implementations, multiple fracturing fluids may be used in the various ramps of a well fracturing operation. In such implementations, properties of all the various fracturing fluids along with their injections rates can be accessed.

At block 404, a numerical algorithm implemented on, for example, a computing device, can be used in conjunction with the trial geometry of each initial defect and the operational hydraulic parameters accessed at block 402 to simulate initiation and propagation of one or more fractures 120 from the initial defect(s). Any numerical algorithm known in the art can be used. In one possible aspect, the numerical algorithm can couple the flow of the fracturing fluid(s) used in the well fracturing operation to the corresponding deformation of the surrounding formation 108.

In one possible implementation, hydraulic fracturing (HF), such as that utilized in a well fracturing operation, can be broadly defined as a process by which a fracture 120 initiates and propagates as a result of hydraulic loading (i.e., fluid pressure) applied by a viscous fracturing fluid inside the fracture 120. In one possible aspect, hydraulic fracturing can include injecting a viscous fracturing fluid (with or without solids known as proppants) into one or more portions of wellbore 102 with sufficient pressure to initiate and propagate fracture 120 in formation 108. In such a manner, a flow channel—including potentially a high-conductivity flow channel—can be created allowing hydrocarbons, water and other substances and/or materials found in formation 108 to flow towards wellbore 102. In one possible aspect, various numerical models known in the art can be used to simulate the hydraulic fracturing process. These models can include, for example, procedures to deal with (i) the mechanical deformation of the rock in reservoir 108 housing the fracture 120, (ii) the flow of fracturing fluid inside the fracture 120, and (iii) a fracture propagation aspect. In one possible embodiment, a numerical model used may include a robust and stable coupling algorithm between the rock deformation and the fluid flow. The deformation of formation 108 during the hydraulic fracturing process can be modeled using any technique known in the art, including for instance, use of linear elasticity modeling techniques.

In one possible implementation, propagation of a fracture 120 together with front tracking schemes can be modeled following linear elastic fracture mechanics and fluid mechanics approaches. For instance, fluid flow inside the fracture 120 can be described using the 2D Reynolds lubrication equation as:

$$\frac{\partial w}{\partial t} + div q = s ,$$

where t is the time variable, w is the crack opening displacement, and s stands for the source term which may include the leak-off effect. The fluid flux q in the fracture 120 can be expressed as:

q=D(∇pρg),

where p is the fluid pressure, ρ is the fluid density, and g represents the gravity vector. For a Newtonian fluid, D=w³/12μ, where μ is the fluid viscosity. For non-Newtonian power-law fluids, D can have a dependence on w as well as on the pressure gradient ∇p.

In one possible embodiment, propagation of fracture 120 can be modeled, for example, using the maximum tangential stress criterion. This condition can be implemented in the model via a comparison of the numerically computed equivalent mode I stress intensity factor and the fracture toughness.

In one possible aspect, in 2D, the equivalent mode I stress intensity factor can be defined from the stress intensity factors K_{I} and K_{II} in mode I (opening) and mode II (sliding), respectively, as:

$${K}_{I , eq} = cos \frac{θ}{2} ( \begin{matrix}{K}_{I} {cos}^{2} \frac{θ}{2} & \frac{3}{2} {K}_{II} sin θ\end{matrix} ) ,$$

where θ is the angle of fracture propagation, corresponding to the maximum tangential (hoop) stress direction ahead of the fracture 120. The stress intensity factors in modes I and II can be computed from the components of the displacement jump across the fracture 120 in the directions normal and tangential to the fracture 120. The normal displacement jump is the fracture width w. The angle of fracture propagation θ can be computed according to the maximum hoop stress condition from the stress intensity factors and/or from the stress field ahead of the crack.

In 3D, the equivalent mode I stress intensity factor can be defined from the stress intensity factors K_{I}, K_{II}, and K_{III} corresponding to the opening (mode I), sliding (mode II) and tearing (mode III) components of the displacement jump. In one possible aspect, according to the generalized maximum tangential stress criterion, the direction of fracture propagation can be computed from the stress intensity factors and/or from the stress field ahead of the fracture 120.

In one possible implementation, a numerical model used to simulate the process of hydraulic fracturing can also include the initiation of a fracture 120 or multiple fractures 120. In one possible aspect, the numerical model can simulate initiation of a fracture 120 or multiple fractures 120 from initial defects of the formation 108 connected to wellbore 102. The numerical model can simulate fluid injection into wellbore 102 and the flow of fluid from wellbore 102 into one or more of the initial defects. Once a critical state of an initial defect has been reached during the fluid injection, a fracture 120 can be initiated from the initial defect and start to propagate into formation 108.

In one possible implementation, a critical state of an initial defect can be defined in the numerical model in any way known in the art, including for example, as a state at which a maximum tensile stress on the initial defect exceeds the tensile strength of formation 108 in which the initial defect is found, and/or as a state at which the averaged tensile stress over a certain area in formation 108 in the vicinity of the initial defect exceeds the tensile strength of formation 108. In one possible aspect, the critical state of a pre-existing initial defect can be defined in the numerical model, for example, as a state at which the equivalent mode I stress intensity factor is equal to fracture toughness of the rock, or as a state at which the energy release rate in the direction of fracture propagation reaches its critical value, or as a state at which the traction or separation within a cohesive zone ahead of the fracture tip reaches its critical value. In one possible aspect, once a fracture 120 is initiated, the numerical model can model propagation of the fracture 120 into formation 108.

In another possible embodiment, the numerical model can simulate fracture initiation from a defect-free, open-hole wellbore 102, such as, for example, when no initial defects are present.

At block 406, the output of the simulation performed at block 404 can include a peak pressure including the highest and/or maximum pressure of fracturing fluid achieved during fracture initiation and propagation, and the fracture opening at the end of the pad and before proppant injection.

The output of the simulation performed at block 404 can also include fracture trajectory and closure stress on the fracture 120 at the end of fracturing fluid injection for the chosen completion type being evaluated in the simulation.

At block 408, if the fracture opening at the end of the pad (and before proppant injection) output at block 406 is less than a given allowed threshold value, reduction routine 400 can proceed to block 410 where the geometry of the initial defect and/or the hydraulic parameters associated with the well fracturing operation can be altered in an attempt to produce a fracture opening large enough to meet the allowable threshold. In one possible implementation, the geometry of the initial defect can be varied at block 410 in such a way as to decrease and/or minimize a peak pressure of fracturing fluids used during the simulated well fracturing operation. The newly varied geometry of the initial defect and/or hydraulic parameters can then be fed back into reduction routine 400 at block 402.

Alternately, if the fracture opening at the end of the pad and before proppant injection output at block 406 is greater than or equal to the given threshold value, reduction routine 400 can proceed to block 412.

In one possible implementation, the allowed threshold value used in block 408 can correspond to a fracture opening of fracture 120 large enough to avoid deleterious issues such as screen-out, etc., during the well fracturing operation being simulated in reduction routine 400. In one possible aspect, the given allowed threshold value can be obtained from specifications of one or more proppants contemplated for use in the well fracturing operation being simulated in reduction routine 400.

In one possible embodiment, block 410 can endeavor to isolate an initial defect geometry that results in a fracture opening greater than or equal to the allowed threshold with a lowest possible allowable peak pressure.

At block 412, if reduction criteria associated with a peak pressure of the fracturing fluid are not satisfied, reduction routine 400 can go to block 410, where the peak pressure of fracturing fluids used during the simulated well fracturing operation can be decreased and/or minimized by varying the geometry of the initial defect and/or the hydraulic parameters associated with the well fracturing operation. The newly varied geometry of the initial defect and/or hydraulic parameters can then be fed back into reduction routine 400 at block 402.

Alternately, if the peak pressure in block 412 is within the allowable operating range and is low enough to avoid various problems (such as, for example, damaging wellbore 102, damaging a wellhead associated with wellbore 102, damaging pumps, completions elements and/or structures associated with wellbore 102, etc.), the reduction criteria associated with the peak pressure of the fracturing fluid are satisfied. Reduction routine 400 can then proceed to block 414, where an improved and/or optimal geometry of the initial defect as well as operational hydraulic parameters to decrease and/or minimize the peak pressure determined at the last iteration of block 402 can be the output. In one possible implementation, when reduction routine 400 is being used in conjunction with improvement workflow 300, the output of block 414 can be fed into and used by block 316.

In one possible implementation, the reduction criteria used in block 412 of reduction routine 400 can be based, for example, on a constrained minimization of the objective function p=f(initial defect design; μ, Q(t)), in which p is the peak pressure, μ is the viscosity of the fracturing fluid, and Q(t) is the injection rate schedule.

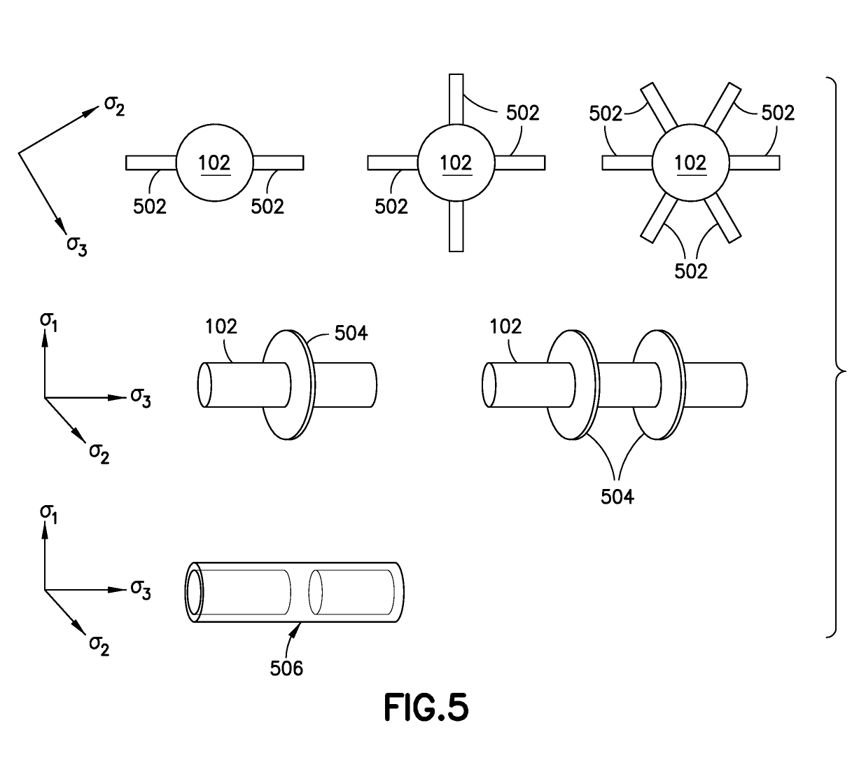

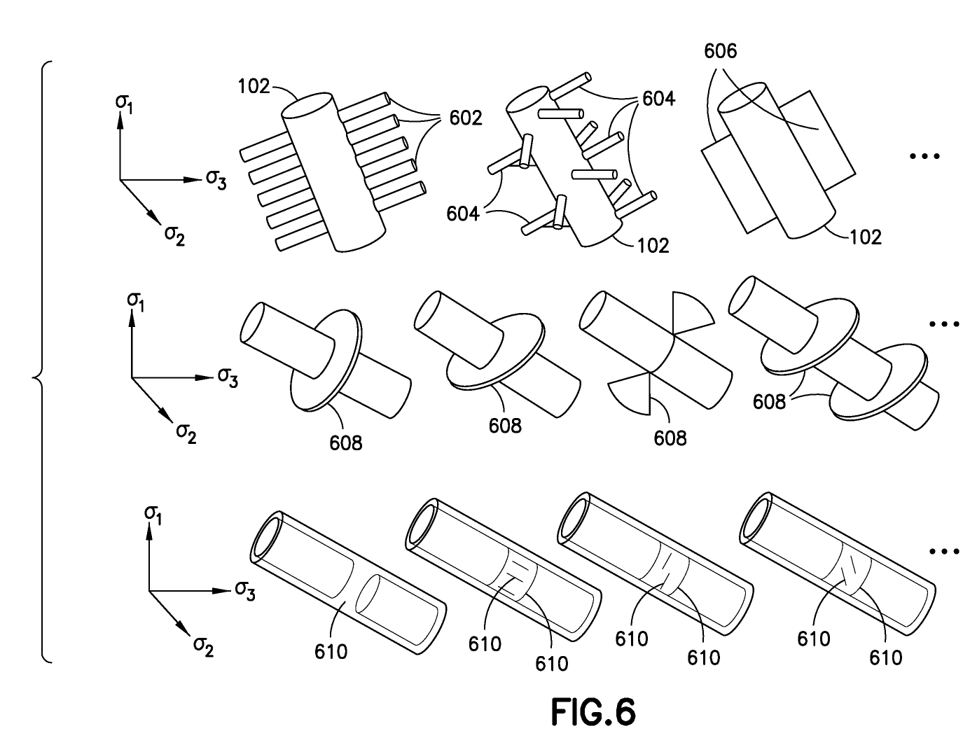

FIGS. 5 and 6 illustrate various example completion geometries of initial defects in accordance with embodiments of hydraulic fracturing design. In FIG. 5, the completion geometries of the initial defects are configured for various 2D and axisymmetric modeling configurations, while in FIG. 6, the completion geometries of the initial defects are configured for various 3D modeling configurations. In both FIG. 5 and FIG. 6, σ₁, σ₂, and σ₃ denote far field in-situ stresses in directions 1, 2 and 3, respectively.

For example, as shown in FIG. 5, various configurations of an open or cased wellbore 102 are shown with varying numbers and types of initial defects extending into formation 108. In one possible implementation, the initial defects can take the form of line perforations 502 extending from wellbore 102 into formation 108. Line perforations 502 can be perforations 118 having any cross-section known in art.

In another possible implementation, the initial defects can take the form of one or more radial notches 504 extending from wellbore 102 into formation 108. Radial notches 504 are one possible type of initial defect exhibiting axisymmetry, and can be formed in any manner known in the art, including through jet blasting of formation 108. Moreover, notches 504 can be at any location.

In yet another possible implementation, a sleeve around wellbore 102 can include an opening in the form of a fracturing sleeve 506 (such as, for example, fracture sleeves 128) acting as an initial defect through which fracturing fluid(s) from wellbore 102 can be placed into contact with formation 108. The term “fracturing sleeve” as used herein, can include anything known in the art separating wellbore 102 from formation 108, including for example, casing 104, cement 106, one or more completions elements, any combination thereof, etc. Moreover, fracturing sleeve 506 can be installed using any methods known in the art, and fracturing sleeve 506 can have any size and configuration known in the art.

FIG. 6 illustrates yet more example configurations of an open or cased wellbore 102 with varying numbers and types of initial defects extending into formation 108. For example, in one possible implementation, initial defects can take the form of aligned perforations 602, spiral perforations 604 and/or longitudinal notches 606 extending from wellbore 102 into formation 108.

In another possible implementation, the initial defects can take the form of one or more radial notches 608 extending from wellbore 102 into formation 108. Radial notches 608 are one possible type of initial defect which may exhibit axisymmetry, and which may have any orientation relative to wellbore 102, can take any shape, and can be formed in any manner known in the art, including through jet blasting of formation 108. Moreover, notches 608 can exhibit any form of angular extent, be at any location and have any orientation known in the art.

In yet another possible implementation, a sleeve around wellbore 102 can include one or more openings in the form of fracturing sleeves 610 (such as, for example, fracture sleeves 128) acting as initial defects through which fracturing fluid(s) from wellbore 102 can be placed into contact with formation 108. As noted above, the term “fracturing sleeves” as used herein, can include anything known in the art separating wellbore 102 from formation 108 (and/or exposing at least a portion of wellbore 102 to formation 108), including for example, casing 104, cement 106, one or more completions elements, any combination thereof, etc. Also, fracturing sleeves 610 can be installed using any methods known in the art, and fracturing sleeves 610 can have any size and configuration known in the art.

It will be understood that the various initial defects illustrated in FIGS. 5 and 6 may be used in any possible combinations in order to model well fracturing operations in accordance with embodiments of hydraulic fracturing design.

In some possible implementations, when fractures 120 are simulated in a well fracturing operation, the simulations can be based on one or more two-dimensional models, such as, for example, when fracture re-orientation is simulated from intervals of line perforations 502 in a vertical wellbore 102. In other possible implementations, simulations can rely on one or more three-dimensional models. Such as, for example, when a tortuous fracture 120 is simulated from an interval of spiral perforations 604 and/or a notch 606 on a horizontal well misaligned with the principal stress directions. In one possible aspect, a numerical algorithm can be used in such simulations. In one possible embodiment, such a numerical algorithm can be based on coupling a fluid flow scheme, such as that modeled by the Reynolds lubrication equation, with a rock deformation solver. In such a way a rock deformation model can be based, for example, on the theory of linear elasticity. In one possible embodiment, such linearly elastic 2D or axisymmetric or 3D models can be built on the basis of the extended finite element method (XFEM) and/or the displacement discontinuity method (DDM) described below, or any other methods known in the art.

In one possible implementation, the extended finite element method (XFEM) is a finite element based method that can model fractures 120 not aligned with the background finite element mesh. In XFEM, the space of approximation functions can be enriched by adding discontinuous and singular functions corresponding to the discontinuities and singularities in the displacement and stress fields associated with fracture 120. In one possible implementation, the pressure of fracturing fluid within fracture 120 can act as the traction boundary condition on the fracture faces. XFEM can solve for the displacement field associated with the trial fluid pressure, and the corresponding fracture opening can be found from the displacement jump. In one possible aspect, the trial fluid pressure can be updated from the solution of, for example, the Reynolds lubrication equation. The coupled XFEM and the lubrication solver can provide a numerical solution for the fluid pressure and the fracture opening. In one possible embodiment, XFEM is a domain-based method and can include modeling of cement 106, casing 104, micro-annulus, as well as poroelastic effects in formation 108.

In one possible implementation, the displacement discontinuity method (DDM) can include a particular class of integral equation techniques for boundary-value problems involving structural discontinuities such as cracks and faults in an infinite elastic medium. In one possible aspect, the DDM can be based on the exact solution of the problem of a constant displacement discontinuity (DD) over a bounded flat area in an infinite elastic solid. In one possible aspect, in the DDM, the primary unknowns (i.e. the DD's) can include the aperture and rides of a fracture 120. In addition, a fracture 120 can be represented as a series of DD's (with different strengths to be determined) distributed on the surface of the fracture 120. Moreover, the principle of superposition, valid within the framework of linear elasticity, can allow for the summing up of the influences of the DD's to obtain the stress field at any point in an infinite elastic medium characterizing a rock mass. Finally, it may be possible to couple the DDM with the lubrication solver to provide a numerical solution for the pressure of fracturing fluid and the fracture opening similar to that of the coupled XFEM algorithm.

### Example Computing System(s)

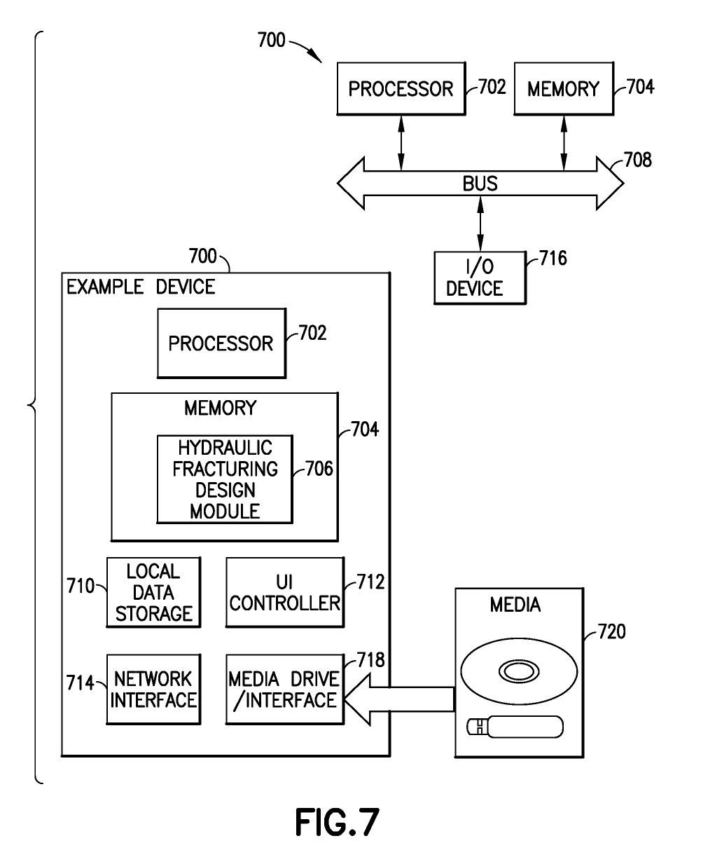

FIG. 7 shows an example system 700, such as one or more computing devices, programmable logic controllers (PLCs), etc., with a processor 702 and memory 704 for hosting a variety of applications/programs such as a hydraulic fracturing design module 706 for implementing various embodiments of hydraulic fracturing design as discussed in this disclosure.

System 700 is one example of a computing device or programmable device, and is not intended to suggest any limitation as to scope of use or functionality of system 700 and/or its possible architectures. In one possible implementation, system 700 can include a laptop computer, a desktop computer, a handheld computing device, a mainframe computer, etc., or any combination or accumulation thereof.

In one possible implementation, system 700 includes one or more processors or processing units 702, one or more memory components 704 (on which, for example, hydraulic fracturing design module 706 may be stored in whole or in part), a bus 708 configured to allow various components and devices to communicate with each other, and local data storage 710, among other components.

Memory 704 may include one or more forms of volatile data storage media such as random access memory (RAM)), and/or one or more forms of nonvolatile storage media (such as read-co memory (ROM), flash memory, and so forth).

Bus 708 can include one or more of any of several types of bus structures, including a memory bus or memory controller, a peripheral bus, an accelerated graphics port, and a processor or local bus using any of a variety of bus architectures. Bus 708 can include wired and/or wireless buses.

Local data storage 710 can include fixed media (e.g., RAM, ROM, a fixed hard drive, etc.) as well as removable media (e.g., a flash memory drive, a removable hard drive, optical disks, magnetic disks, and so forth).

A user interface (UI) device may also communicate via a user interface (UI) controller 712, which may connect with the UI device either directly or through bus 708.

In one possible implementation, a network interface 714 may communicate outside of system 700 via a connected network, and in some implementations may communicate with hardware, such as sensors, downhole equipment, surface equipment, etc.

In one possible embodiment, users and devices may communicate with system 700 via one or more input/output devices 716 via bus 708 and via a USB port, for example. In one possible implementation, input/output devices 716 can include various devices capable of sending and/or receiving laser and/or optical information and converting between laser and/or optical information and digital information suitable for use by system 700.

A media drive/interface 718 can accept removable tangible media 720, such as flash drives, optical disks, removable hard drives, software products, etc. In one possible implementation, logic, computing instructions, and/or software program comprising elements of the hydraulic fracturing design module 706 may reside on removable media 720 readable by media drive/interface 718.

In one possible embodiment, one or more input/output devices 716 can allow a user to enter commands and information to system 700, and also allow information to be presented to the user and/or other components or devices. Examples of input/output devices 716 include, in some implementations, sensors, a keyboard, a cursor control device (e.g., a mouse), a microphone, a scanner, and any other input devices known in the art. Examples of input/output devices 716 can also include a display device (e.g., a monitor or projector), speakers, a printer, a network card, and so on.

Various processes of hydraulic fracturing design module 706 may be described herein in the general context of software or program modules, or the techniques and modules may be implemented in pure computing hardware. Software generally includes routines, programs, objects, components, data structures, and so forth that perform particular tasks or implement particular abstract data types. An implementation of these modules and techniques may be stored on or transmitted across some form of tangible computer-readable media. Computer-readable media can be any available data storage medium or media that is tangible and can be accessed by a computing device. Computer readable media may thus comprise computer storage media.

“Computer storage media” designates tangible media, and includes volatile and non-volatile, removable and non-removable tangible media implemented for storage of information such as computer readable instructions, data structures, program modules, or other data. Computer storage media include, but are not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other tangible medium which can be used to store the desired information, and which can be accessed by a computer.

Although a few example embodiments have been described in detail above, those skilled in the art will readily appreciate that many modifications are possible in the example embodiments without materially departing from this disclosure. Accordingly, such modifications are intended to be included within the scope of this disclosure as defined in the following claims. Moreover, embodiments may be performed in the absence of any component not explicitly described herein.

In the claims, means-plus-function clauses are intended to cover the structures described herein as performing the recited function and not just structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures. It is the express intention of the applicant not to invoke 35 U.S.C. § 112, paragraph 6 for any limitations of any of the claims herein, except for those in which the claim expressly uses the words ‘means for’ together with an associated function.

1. A computer-readable tangible medium with instructions stored thereon that, when executed, direct a processor to perform acts comprising:
accessing one or more initial conditions of a wellbore;
accessing one or more potential completion types;
determining a desirable finalized fracturing design for the wellbore by iteratively varying one or more fracturing properties for each of the one or more potential completion types.

2. The computer-readable medium of claim 1, further including instructions to direct a processor to perform acts comprising:
accessing the one or more initial conditions of the wellbore by accessing one or more of:
a geometry of the wellbore;
one or more measured geomechanical properties of a formation along the wellbore;
one or more pieces of equipment associated with the wellbore;
one or more structures associated with the wellbore.

3. The computer-readable medium of claim 1, further including instructions to direct a processor to perform acts comprising:
accessing the one or more potential completion types by accessing one or more of:
an open hole completion design;
a cased hole completion design;
a cased hole completion design with sleeves.

4. The computer-readable medium of claim 1, further including instructions to direct a processor to perform acts comprising:
iteratively varying one or more fracturing properties by iteratively varying one or more of:
one or more operational hydraulic parameters;
one or more properties associated with one or more initial defects in the formation adjacent to the wellbore.

5. The computer-readable medium of claim 4, further including instructions to direct a processor to perform acts comprising:
iteratively varying the one or more properties associated with the one or more initial defects by varying one or more of:
types of the one or more initial defects;
depths of penetration of the one or more initial defects;
dimensions of the one or more initial defects;
locations of the one or more initial defects.

6. The computer-readable medium of claim 1, further including instructions to direct a processor to perform acts comprising:
determining the desirable finalized fracturing design by choosing the desirable finalized fracturing design from a plurality of finalized fracturing designs, wherein each finalized fracturing design achieves a pressure of a fracturing fluid within an allowable operating range.

7. The computer-readable medium of claim 1, further including instructions to direct a processor to perform acts comprising:
determining the desirable finalized fracturing design by choosing the desirable finalized fracturing design from a plurality of finalized fracturing designs, wherein each finalized fracturing design achieves a pressure of a fracturing fluid high enough at the end of a pad such that an opening of a fracture is no smaller than a given allowed threshold value.

8. A computer-readable tangible medium with instructions stored thereon that, when executed, direct a processor to perform acts comprising:
accessing one or more initial conditions of a wellbore;
accessing one or more potential completion types;
isolating one or more finalized fracturing designs, wherein each of the one or more finalized fracturing designs is associated with one of the one or more completion types;
choosing a desirable finalized fracturing design from the one or more finalized fracturing designs.

9. The computer-readable medium of claim 8, further including instructions to direct a processor to perform acts comprising:
accessing the one or more initial conditions of the wellbore by accessing one or more of:
a geometry of the wellbore;
one or more measured geomechanical properties of a formation along the wellbore;
one or more pieces of equipment associated with the wellbore;
one or more structures associated with the wellbore.

10. The computer-readable medium of claim 8, further including instructions to direct a processor to perform acts comprising:
accessing one or more potential completion types by accessing one or more of:
an open hole completion design;
a cased hole completion design;
a cased hole completion design with sleeves.

11. The computer-readable medium of claim 8, further including instructions to direct a processor to perform acts comprising:
isolating the one or more finalized fracturing designs by varying one or more of a variety of fracturing properties to decrease a peak pressure of a fracturing fluid to at or below an allowable peak pressure and create a fracture opening in a formation proximate the wellbore at or above an allowed threshold.

12. The computer-readable medium of claim 11, further including instructions to direct a processor to perform acts comprising:
varying one or more of a variety of fracturing properties by varying one or more of:
a type of one or more initial defects;
a geometry of one or more initial defects;
a number of one or more initial defects;
a spacing of one or more initial defects;
a depth of penetration of one or more initial defects;
a dimension of one or more initial defects;
a location of one or more initial defects.

13. The computer-readable medium of claim 11, further including instructions to direct a processor to perform acts comprising:
determining the allowed threshold by referencing specifications for a proppant to be used in a proposed hydraulic fracturing process in the wellbore.

14. The computer-readable medium of claim 8, further including instructions to direct a processor to perform acts comprising:
determining the desirable finalized fracturing design as the finalized fracturing design which will cost the least to implement.

15. The computer-readable medium of claim 8, further including instructions to direct a processor to perform acts comprising:
commencing a well fracturing operation based at least partially on the desirable finalized fracturing design.

16. A computer-readable tangible medium with instructions stored thereon that, when executed, direct a processor to perform acts comprising:
accessing one or more initial conditions of a wellbore;
accessing a potential completion type;
isolating a finalized fracturing design associated with the potential completion type by varying one or more fracturing properties, wherein the finalized fracturing design includes a pressure of fracturing fluid low enough to be at or below an allowable peak pressure and high enough to initiate and propagate a fracture in a formation with an opening at or above an allowed threshold value.

17. The computer-readable medium of claim 16, further including instructions to direct a processor to perform acts comprising:
accessing one or more initial conditions of a wellbore by accessing one or more of:
a geometry of the wellbore;
one or more measured geomechanical properties of a formation along the wellbore;
one or more pieces of equipment associated with the wellbore;
one or more structures associated with the wellbore.

18. The computer-readable medium of claim 16, further including instructions to direct a processor to perform acts comprising:
accessing one or more potential completion types by accessing one or more of:
an open hole completion design;
a cased hole completion design;
a cased hole completion design with sleeves.

19. The computer-readable medium of claim 16, further including instructions to direct a processor to perform acts comprising:
varying the one or more fracturing properties by varying one or more of:
a geometry of one or more initial defects;
a type of one or more initial defects;
a number of one or more initial defects;
a depth of penetration of one or more initial defects;
a dimension of one or more initial defects;
a spacing of one or more initial defects;
a location of one or more initial defects.

20. The computer-readable medium of claim 16, further including instructions to direct a processor to perform acts comprising:
isolating the finalized fracturing design associated with the potential completion type by creating a plurality of possible fracturing designs associated with the potential completion type and choosing the desirable possible fracturing design to be the finalized fracturing design for the potential completion type.
